(19) United States
(12) Patent Application Publication
(10) Pub. No.: US 2024/0375691 A1
(43) Pub. Date: Nov. 14, 2024

(54) FIRE-PROTECTED FLOOR STRUCTURE OF A WAGON BODY OF LIGHTWEIGHT CONSTRUCTION

(71) Applicant: 3A COMPOSITES MOBILITY AG, Altenrhein (CH)

(72) Inventors: Markus Hartwig, St. Gallen (CH); Panagiotis Michos, Romanshorn (CH)

(73) Assignee: 3A COMPOSITES MOBILITY AG, Altenrhein (CH)

(21) Appl. No.: 18/684,015

(22) PCT Filed: Aug. 29, 2022
(86) PCT No.: PCT/EP2022/073976

§ 371 Date: Feb. 15, 2024

(30) Foreign Application Priority Data
Aug. 31, 2021 (EP) 21194142.2

(51) Int. Cl. B61D 17/18; B60R 13/08; B61D 17/10; B62D 25/20

(52) U.S. Cl. CPC B61D 17/18; B60R 13/0815; B61D 17/10; B62D 25/2072

(57) ABSTRACT

Fire-protected floor structure of a wagon body containing a sandwich plate (5) made of a metallic top layer (10) and a metallic base layer (20) and a core layer (30) lying therebetween as well as metallic edge profiles (40). The core layer (30) is completely enclosed by the metallic top and base layers (10, 20) and the edge profiles (40). The floor structure has a mineral coolant layer (60) on the side of the base layer (20) facing away from the core layer (30) and the side of the mineral coolant layer (60) facing away from the core layer (30) is covered with an intumescent layer (70). The core layer (30) is made of a structural foam, in particular of PET foam, or of balsa wood, or contains at least 95% by weight of PET or balsa wood.

### BACKGROUND OF THE INVENTION

The invention relates to a fire-protected floor structure of a wagon body for rail or road transportation vehicles of lightweight construction.

The ASTM E119 standard is often required for floor structures of rail or road transportation vehicles, i.e. in the event of fire with temperatures of up to 840-860° C., the surface temperature on the top layer of the floor structure must not exceed an average temperature of 140° C. for 30 minutes and a floor structure loaded with 400 kg/m² must not collapse for 30 minutes.

Fireproof underframe floor structures for rail vehicles are known per se from the state of the art. Accordingly, CN110641491A describes a method of producing an underframe fire protection floor structure for rail vehicles comprising a floor-load bearing frame and a floor laid on the floor-load bearing frame, wherein the floor-load bearing frame is integrally welded by using carbon steel and has a rectangular outer frame and a plurality of cross members. Hat-shaped fire protection plates with downward-facing upper sides are arranged between two adjacent cross members and the side walls of the hat-shaped fire protection plates are clamped between the two adjacent cross members. The two edges of the hat-shaped fireproof plates are correspondingly and integrally connected to the upper top surfaces of the two adjacent cross members. The floor is connected to each cross member by using an adhesive and cold-resistant and heat-insulating materials consisting of ceramic fibers are arranged between the floor and the hat-shaped fireproof plates.

CN210454809A describes a floor structure for a rail vehicle, wherein the floor structure comprises a layer made of stainless-steel sheet and a heat insulation layer is arranged on the stainless-steel layer. An aluminum profile floor frame is arranged on the heat insulation layer.

US2018/0215398A1 describes a floor structure, which is provided with an underframe, which is part of a wagon body. The underframe extends along a longitudinal axis which coincides with the feed axis of such a car, and which has a plurality of longitudinal attachment rails arranged on an area of the lower surface of the underframe. The attachment rails project downwards so as to define therebetween a plurality of compartments, into which plates with insulating material are inserted to form a fire protection system.

EP0806539A1 describes a laminated composite floor for railroad wagons with internal cavities at least one of which is filled with an intumescent material. When exposed to fire, such an article retards or prevents the break-through of fire into an adjoining compartment or an adjoining room for a sufficient time to allow passengers thereof to evacuate the adjoining compartment or to extinguish the fire. The intumescent material meets the requirements of ASTM E152.

U.S. Pat. No. 6,114,003 describes a flame and heat resistant insulation plate which is used to protect hulls, bulkheads, overheads, and compartments of ships, aircraft, railway tanker cars, and tanker trucks. The insulation plate has an inner core air cell made of metal with a first side for receiving a first composite and a second side for receiving a second composite. The composites have an inner layer formed of a metal foil, a ceramic-based middle layer, and an outer layer of an intumescent, fire-retardant coating on a fiber glass sheet.

The problem with the production of fire-protected floor structures for wagon bodies of rail or road vehicles is the high weight of the floor structures known from the state of the art, which meet the fire protection requirements according to ASTM E119.

### SUMMARY OF THE INVENTION

The object of the present invention is to provide a fire-protected floor structure of a wagon body for rail or road transportation vehicles of lightweight construction, which meets the requirements of the ASTM E119 test protocol. Thus, this floor structure must maintain a barrier against the fire on the protected side of the floor structure, i.e. the inside of the wagon, and provide a sufficient structural integrity to maintain the load-bearing capacity of the floor structure even in the event of a fire. A further object of the invention relates to the simple installation of a floor structure into the wagon body.

These objects are met by a fire-protected floor structure as disclosed herein. Preferred embodiments of the floor structure are described herein and in the claims that are directly or indirectly dependent on the independent claim.

The fire-protected floor structure according to the invention of a wagon body for rail or road vehicles containing connecting profiles has a sandwich plate made of a metallic top layer and a metallic base layer and a layer lying therebetween made of a core layer of non-fireproof material as well as metallic edge profiles. Here, the edge profiles are configured in such a way that the core layer is completely enclosed by the metallic top and base layers and the edge profiles. The floor structure has a mineral coolant layer on the side of the base layer facing away from the core layer and intumescent hard layer plates in areas for attaching connecting profiles, wherein an inner area on the side of the hard layer plates facing away from the sandwich plate has an intumescent adhesive layer area in each case. Thus, the side of the base layer facing away from the core layer is covered over the entire surface by the mineral coolant layer and the intumescent hard layer plates, since either the intumescent hard layer plates or the mineral coolant layer is located on the base layer, i.e. the mineral coolant layer surrounds the intumescent hard layer plates. The side of the mineral coolant layer facing away from the sandwich plate as well as at least one edge area of the areas of the hard layer plates not covered with the intumescent adhesive are covered with an intumescent layer. The connecting profiles are each bonded in an inner area on the side of the intumescent adhesive layer areas facing away from the sandwich plate.

The non-fireproof material of the core layer means in particular that it can react with the oxygen in the air, releasing radiant energy or heat, and continues to burn after ignition, even if the ignition source is removed.

Core layers made of non-fireproof material according to the present invention are core layers made of structural foam, in particular core layers made of PET foam, or core layers made of balsa wood, in particular balsa wood end grain boards. In this context, structural foam means a foam with a cellular structure. Core layers containing at least 95% by weight PET or balsa wood are also preferred.

Intumescent materials foam when exposed to heat, i.e. they increase in volume and correspondingly decrease in density when exposed to heat. The increase in volume of the intumescent materials is expediently up to 20 times the original material volume.

Rail vehicles for the application of the present floor structure are in particular railroad, metro, suburban and subway trains, and streetcars. Preferred applications of the floor structures according to the invention in road vehicles are in particular the wagon bodies of buses and other non-railbound public transport vehicles. Particularly preferred applications refer to battery-powered vehicles (e-mobility). The metallic top and base layers as well as the edge profiles of the sandwich plate are preferably made of aluminum.

The mineral coolant layer—with the exception of the areas that have intumescent hard layer plates—is preferably bonded to the entire surface of the base layer, preferably with a two-component polyurethane or epoxy resin adhesive.

The mineral coolant layer is preferably made of a layer of cement-bonded calcium silicate. The cooling effect is based on the endothermic evaporation of hydrated minerals. The mineral coolant layer is expediently 1 to 3 mm thick. Preferably, the commercial product ENEX is used. ENEX is made of metal hydrates and is a mineral coolant which absorbs large amounts of heat when heated above a limit temperature. The effect is based on the evaporation of hydrated minerals.

The intumescent layer—with the exception of the areas of the hard layer plates covered with intumescent adhesive—is preferably bonded over the entire surface of the mineral coolant layer as well as in each case over an edge area of the intumescent hard layer plates. Preferably, a two-component polyurethane adhesive is used.

The intumescent layer is preferably made of an intumescent fleece, wherein the fleece is preferably made of silicate fibers. The intumescent layer is expediently 0.7 to 3 mm thick. Preferably, the commercial product PYRO-SAFE is used for the intumescent layer.

The floor structure has a substantially rectangular structure in top view with a width expediently between 1.5 m and 4 m, preferably between 2 m and 3 m, and a length expediently between 6 m and 25 m, preferably between 10 m and 20 m.

The floor structure is preferably configured to be self-supporting, wherein the sandwich plate has a thickness of expediently 30 mm to 80 mm and preferably 50 mm to 70 mm.

The top and base layers of the sandwich preferably have a thickness of 1.0 to 2.0 mm.

The intumescent hard layer plates are preferably made of a graphite-based plate material. An intumescent hard layer plate is required in each case to attach a connecting profile, since the profile cannot be securely bonded to the intumescent layer.

The intumescent hard layer plates are preferably made of intumescent fleece pressed under high pressure, as described above, for example.

Connecting profiles, preferably C-rails for receiving pipes or conduits are located on the exposed surface areas of the intumescent hard layer plates, wherein these connecting profiles are preferably attached to the intumescent hard layer plates by means of an intumescent adhesive.

The floor structure according to the invention is preferably connected to the walls of the wagon body via the edge profiles of the sandwich by means of fixing means. Fixing can be achieved, for example, by welding or by means of screws, rivets or adhesive.

### BRIEF DESCRIPTION OF THE DRAWINGS

The invention is further explained with reference to the following exemplary drawings.

FIG. 1 shows a schematic cross-section through a floor structure according to the invention of a wagon body with a connecting profile;

FIG. 2 shows a perspective view, seen from the vehicle floor, on a section of a floor structure according to the invention of a wagon body of a rail or road vehicle with a connecting profile;

FIG. 3 shows another perspective view, seen from the vehicle floor, on a section of a floor structure according to the invention of a wagon body of a rail or road vehicle with a connecting profile;

FIG. 4 shows a perspective view on the surface of a floor structure according to the invention;

FIG. 5 shows a perspective view on the underside of a floor structure according to the invention with a plurality of connecting profiles.

### DETAILED DESCRIPTION

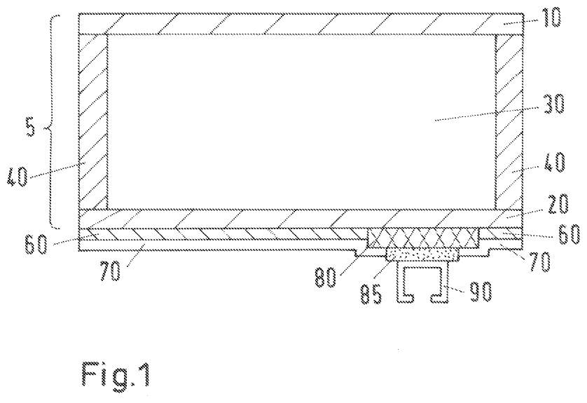

FIG. 1 shows a schematic cross-section through a floor structure according to the invention of a wagon body with a connecting profile. The floor structure has a sandwich plate 5 which contains a metallic top layer 10 and a metallic base layer 20, a layer lying therebetween made of a core layer 30 of non-fireproof material as well as metallic edge profiles 40, wherein the edge profiles 40 are configured in such a way that the core layer 30 is completely enclosed by the metallic top and base layers 10, 20 and the edge profiles 40. The floor structure has a mineral coolant layer 60 on the side of the base layer 20 facing away from the core layer 30 or, in an area for attaching the connecting profiles 90, an intumescent hard layer plate 80, so that the side of the base layer 20 facing away from the core layer 30 is fully covered either with the mineral coolant layer 60 or with the intumescent hard layer plate 80. An inner area on the side of the hard layer plates 80 facing away from the sandwich plate 5 has an intumescent adhesive layer area 85. In this context, the term “inner area” is understood as an inner area of the hard layer plate as seen from the top view on the hard layer plate. The side of the mineral coolant layer 60 facing away from the sandwich plate 5 as well as the area of the hard layer plate 80 not covered with the intumescent adhesive 85 are covered with an intumescent layer 70. Thus, the intumescent layer 70 covers the entire mineral coolant layer 60 and overlaps the part of the hard layer plate 80 not covered with the intumescent adhesive layer 85. The connecting profile 90 is bonded to the side of the intumescent adhesive layer 85 facing away from the sandwich plate 5, wherein the connecting profile is located in an inner area of the intumescent adhesive layer 85, so that there is a gap between the connecting profile 90 and the outer edge of the intumescent adhesive layer 85. The inner area of the intumescent adhesive layer again refers to the inner area as seen from the top view on the intumescent adhesive layer. The connecting profile is a C-rail, whereby the “C” refers to the cross-section of the longitudinal rail. In top view on the underside of the floor structure, the intumescent adhesive layer 85 can have any shape and in particular be circular, oval, or rectangular.

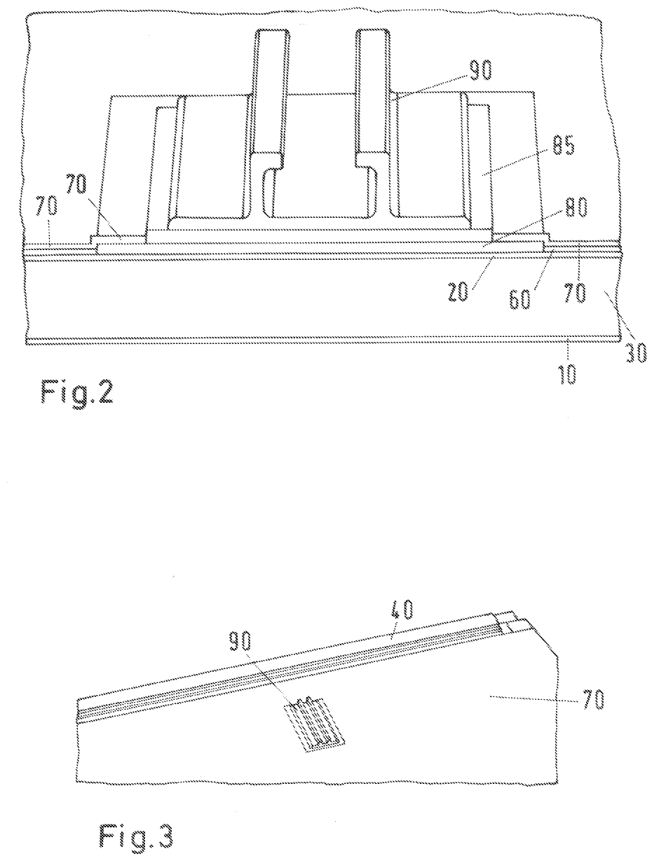

FIG. 2 shows a perspective view, seen from the vehicle floor, on a section of a floor structure according to the invention of a wagon body of a rail or road vehicle with a connecting profile. When the floor structure according to the invention is attached to a wagon body, the fastening elements-such as a single C-rail in this case—are directed towards the floor of the vehicle or towards the wheels.

In the lower part, FIG. 2 shows the sandwich structure 5 with the top and base layers 10, 20, which enclose a core layer 30 made of non-fireproof material. A mineral coolant layer 60 can be seen on the side of the base layer 20 facing away from the core layer 30 and an intumescent hard layer plate 80 can be seen in an area for attaching the connecting profile 90. An inner area on the side of the hard layer plate 80 facing away from the core layer 30 has an intumescent adhesive layer 85. The side of the mineral coolant layer 60 facing away from the core layer 30 as well as the area of the hard layer plate 80 not covered with the intumescent adhesive 85 is covered with an intumescent layer 70. Thus, the intumescent layer 70 covers the entire mineral coolant layer 60 and overlaps at least an edge area of the part of the hard layer plate 80 not covered with the intumescent adhesive layer area 85. The C-rail 90 is bonded to the side of the intumescent adhesive layer 85 facing away from the core layer 30. The intumescent hard layer plate 80 has a rectangular shape and its edge area is indicated in FIG. 2 by the rectangular line on the surface of the intumescent layer 70. The intumescent adhesive layer 85 also has a rectangular surface shape, wherein its extension is located within the intumescent hard layer plate 80.

FIG. 3 shows another perspective view, seen from the vehicle floor, on a section of a floor structure according to the invention of a wagon body of a rail or road vehicle with a connecting profile. FIG. 3 shows the floor structure with edge profile 40 and the outer surface of the intumescent layer 70. A C-rail 90 projects from the intumescent layer 70.

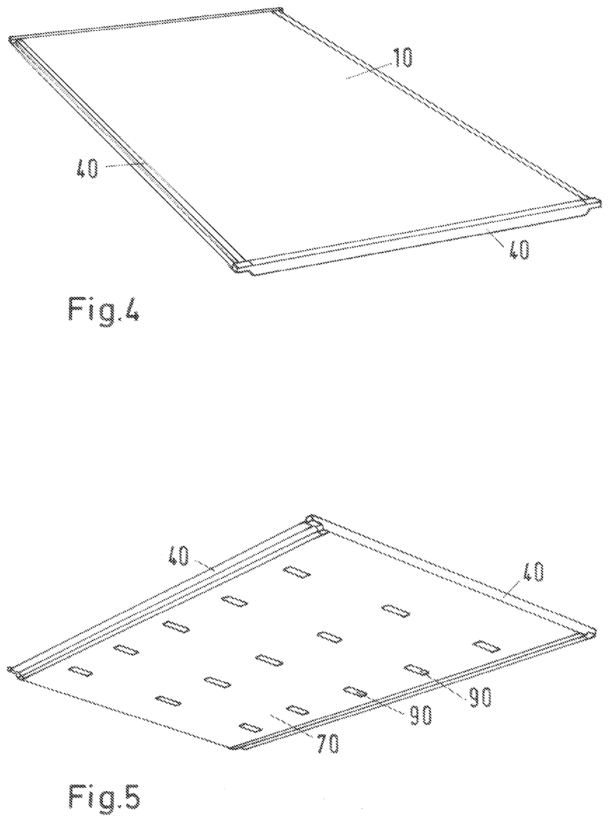

FIG. 4 shows a perspective view on the surface of a floor structure according to the invention, wherein the surface is formed by the metallic top layer 10. Furthermore, FIG. 4 shows the circumferential edge profile 40 of the sandwich plate 5.

FIG. 5 shows a perspective view on the underside of a floor structure according to the invention with a plurality of connecting profiles attached thereto, wherein the lower surface is formed by the intumescent layer 70 and a plurality of C-rails projecting from the surface of the intumescent layer 70. Furthermore, FIG. 5 shows the circumferential edge profile 40 of the sandwich plate 5.

In the following, two fire protection tests carried out according to ISO 834-1 based on ASTM E 119 are briefly explained.

### Test 1:

A square floor plate with a surface of 0.35 m² was loaded with a weight of 1470 newtons. The floor plate was made of an aluminum top layer and an aluminum base layer, each of a thickness of 1 mm, and with a core layer lying therebetween made of PET foam as well as metallic edge profiles made of aluminum. The edge profiles were designed in such a way that the core layer was completely enclosed by the metallic top and base layers and the edge profiles. The floor plate had a 2 mm thick mineral coolant layer made of ENEX on the side of the base layer facing away from the core layer and an intumescent hard layer plate made of PYRO-SAVE, an intumescent fleece pressed under high pressure, in an area for attaching a C-shaped connecting rail. An inner area on the side of the hard layer plate facing away from the core layer had an intumescent adhesive layer area and the side of the mineral coolant layer made of ENEX facing away from the core layer as well as at least one edge area of the area of the hard layer plate not covered with the intumescent adhesive was covered with a 2.2 mm thick intumescent layer of PYRO-SAVE. A connecting profile was bonded in an inner area on the side of the intumescent adhesive layer area facing away from the core layer.

Then, the floor plate was placed in an oven and tested according to ISO 834-1 in compliance with the standard temperature curve according to DIN EN 1363-1. The test procedure according to ISO 834-1 corresponds in part to the ASTM E119 test. The temperature measurement was achieved on the top layer in the middle of the floor plate. Here, the top layer of the floor plate was heated from 20° C. to 862° C. over a time period of 35 minutes according to the following Table 1, wherein the structure of the floor plate was still intact after 35 minutes.

TABLE 1
temperature-time curve according to DIN EN 1363-1

| | measured surface |
|---|---|
| time from | temperature on |
| start of test | the top layer |
| [min] | [° C.] |
| 0 | 20 |
| 1 | 123 |
| 2 | 220 |
| 3 | 330 |
| 4 | 434 |
| 5 | 538 |
| 6 | 571 |
| 7 | 604 |
| 8 | 638 |
| 9 | 671 |
| 10 | 704 |
| 11 | 720 |
| 12 | 731 |
| 13 | 740 |
| 14 | 749 |
| 15 | 758 |
| 16 | 766 |
| 17 | 773 |
| 18 | 780 |
| 19 | 787 |
| 20 | 794 |
| 21 | 799 |
| 22 | 804 |
| 23 | 810 |
| 24 | 815 |
| 25 | 821 |
| 26 | 825 |
| 27 | 829 |
| 28 | 834 |
| 29 | 838 |
| 30 | 843 |
| 31 | 847 |
| 32 | 851 |
| 33 | 854 |
| 34 | 858 |
| 35 | 862 |

### Test 2:

As a comparative test, an identical floor plate with the same structure as in the first test, but without a mineral coolant layer, was tested according to the guidelines of ISO 834-1, wherein a 2 mm thick layer made of Sika Unitherm Platinum was used as the intumescent layer. Sika Unitherm Platinum is a solvent-free 2K fire protection coating based on epoxy resin with 100% solids volume.

The floor plate was again placed in an oven and tested according to ISO 834-1 in compliance with the standard temperature curve according to DIN EN 1363-1. However, the test had to be stopped after 18 minutes since the permissible temperature-time curve according to DIN EN 1363-1 was exceeded and the floor plate burned.

1. Fire-protected floor structure of a wagon body, wherein the floor structure has a sandwich plate (5) made of a metallic top layer (10) and a metallic base layer (20) and a core layer (30) lying therebetween as well as metallic edge profiles (40), wherein the edge profiles (40) are configured in such a way that the core layer (30) is completely enclosed by the metallic top and base layers (10, 20) and the edge profiles (40), and the floor structure has a mineral coolant layer (60) on the side of the base layer (20) facing away from the core layer (30) and the side of the mineral coolant layer (60) facing away from the core layer (30) is covered with an intumescent layer (70),
wherein
the core layer (30) is made of a structural foam or of balsa wood or contains at least 95% by weight of PET or balsa wood.

2. Fire-protected floor structure according to claim 1, wherein the metallic top and base layers (10, 20) as well as the edge profiles (40) of the sandwich plate (5) are made of aluminum.

3. Fire-protected floor structure according to claim 1, wherein the mineral coolant layer (60) is bonded over the entire surface of the base layer (20) with a two-component polyurethane adhesive.

4. Fire-protected floor structure according to claim 1, wherein the floor structure contains connecting profiles (90) arranged on the side of the base layer (20) facing away from the core layer (30), wherein the floor structure has intumescent hard layer plates (80) on the side of the base layer (20) facing away from the core layer (30) in areas for attaching the connecting profiles (90), wherein an inner area on the side of the hard layer plates (80) facing away from the sandwich plate has an intumescent adhesive layer area (85) in each case and the side of the mineral coolant layer (60) facing away from the core layer (30) as well as at least one edge area of the areas of the hard layer plates (80) not covered with the intumescent adhesive (85) are covered with the intumescent layer (70) and the connecting profiles (90) are bonded in an inner area on the side of the intumescent adhesive layer areas (85) facing away from the core layer (30).

5. Fire-protected floor structure according to claim 4, wherein, outside the areas of the base layer (20) which have intumescent hard layer plates (80), the mineral coolant layer (60) is bonded over the entire surface of the base layer (20) with a two-component polyurethane adhesive.

6. Fire-protected floor structure according to claim 4, wherein the intumescent layer (70) is bonded over the entire surface of the mineral coolant layer (60) as well as in each case over an edge area of the intumescent hard layer plates with a two-component polyurethane adhesive.

7. Fire-protected floor structure according to claim 1, wherein the mineral coolant layer (60) is made of a layer made of cement-bonded calcium silicate.

8. Fire-protected floor structure according to claim 7, wherein the mineral coolant layer (60) is 1 mm to 3 mm thick.

9. Fire-protected floor structure according to claim 1, wherein the intumescent layer (70) is made of an intumescent fleece, wherein the fleece is made of silicate fibers.

10. Fire-protected floor structure according to claim 9, wherein the intumescent layer (70) is 0.7 mm to 3.0 mm thick.

11. Fire-protected floor structure according to claim 1, wherein the floor structure has a substantially rectangular structure in top view with a width expediently between 1.5 m and 4 m and a length expediently between 6 m and 25 m.

12. Fire-protected floor structure according to claim 1, wherein the floor structure is configured to be self-supporting, wherein the sandwich plate (5) has a thickness of expediently 30 mm to 80 mm.

13. Fire-protected floor structure according to claim 1, wherein the top and base layers (10, 20) of the sandwich (5) have a thickness of 1.0 mm to 2.0 mm.

14. Fire-protected floor structure according to claim 4, wherein the intumescent hard layer plate (80) is made of a graphite-based plate material.

15. Fire-protected floor structure according to claim 4, wherein the exposed surface of the intumescent hard layer plate (80) has at least one C-profile (90) for receiving pipes or conduits, wherein the at least one C-profile (90) is attached to the intumescent hard layer plate (80) by means of an intumescent adhesive.

16. Fire-protected floor structure according to claim 1, wherein the floor structure is attached to walls of the wagon body via the edge profiles of the sandwich plate (5) by means of fixing means.

17. Fire-protected floor structure according to claim 1, wherein the wagon body is a wagon body for road or rail vehicles.

18. Fire-protected floor structure according to claim 1, wherein the structural foam is PET foam, the balsa wood is a balsa wood end grain board.

19. Fire-protected floor structure according to claim 11, wherein the width is between 2 m and 3 m and the length is between 10 m and 20 m.

20. Fire-protected floor structure according to claim 12, wherein the thickness of the sandwich plate (5) is 50 mm to 70 mm.
